(19) United States
(12) Patent Application Publication
(10) Pub. No.: US 2008/0036941 A1
(43) Pub. Date: Feb. 14, 2008

(54) Backlight module and liquid crystal display device using same

(75) Inventors: Gang-Qiang Zheng, Shenzhen (CN); Hong-Xin Mo, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/891,804

(22) Filed: Aug. 13, 2007

(30) Foreign Application Priority Data
Aug. 11, 2006 (TW) 95129580

(51) Int. Cl. G02F 1/13357; G02B 5/00

(52) U.S. Cl. 349/65; 362/606

(57) ABSTRACT

An exemplary backlight module (23) includes a light guide plate (232) having a bottom surface (2321) and a light incident surface (2322) adjacent to the bottom surface, a light source (230) disposed adjacent to the light incident surface of the light guide plate and a reflective film (231) disposed adjacent to the light guide plate. The reflective film faces the light source and abuts the bottom surface of the light guide plate. The reflective film includes a reflective layer (2313) and a metal shielding layer (2315). A liquid crystal display device using the backlight module is also provided.

### FIELD OF THE INVENTION

The present invention relates to backlight modules such as those used in liquid crystal display (LCD) devices; and particularly to a backlight module having a reflective film being capable of shielding electromagnetic interference (EMI), and an LCD device using the backlight module.

### BACKGROUND

LCD devices are commonly used as displays for compact electronic apparatuses. A conventional LCD device includes a backlight module and a liquid crystal panel. The liquid crystal panel includes various kinds of high frequency circuits, digital circuits, analog circuits and so on. However, when electromagnetic radiation originating from an external source enters the liquid crystal panel, the circuits are liable to sustain EMI. Furthermore, the operation of these circuits generates electromagnetic radiation, which is believed to be potentially harmful to human health.

In recent years, numerous means for shielding to prevent EMI have been developed. One of these is the use of a metal frame that is grounded. The metal frame shields the signal sources that generate electromagnetic radiation.

Referring to FIG. 5, a conventional LCD device 1 includes a backlight module 10, a liquid crystal panel 16 opposite to the backlight module 10, a metal frame 17, and an upper frame 18. The metal frame 17 is capable of shielding the LCD device 1 to prevent EMI, and preventing a user from being exposed to electromagnetic radiation generated from the LCD device 1. The backlight module 10 includes a light source 11, a reflector 12, a light guide plate (LGP) 13, a diffuser 14, and a brightness enhancement film (BEF) 15. The reflector 12, the LGP 13, the diffuser 14, and the BEF 15 are arranged in that order from bottom to top. The light source 11 is disposed adjacent to a side surface of the LGP 13. The metal frame 17 includes a bottom plate 171 and two opposite side plates 173 vertically extending from sides of the bottom plate 171, so as to form an accommodating space (not labeled).

When the LCD device 1 is assembled, the liquid crystal panel 16 is disposed on the BEF 15 of the backlight module 10, and the liquid crystal panel 16 and the backlight module 10 are both disposed in the accommodating space of the metal frame 17. Then the upper frame 18 is attached on the metal frame 17, thereby holding the liquid crystal panel 16 and the backlight module 10 therebetween.

The liquid crystal panel 16 and the backlight module 10 are contained between the upper frame 18 and the metal frame 17. Due to the metal frame 17, the LCD device 1 is protected from external electromagnetic radiation that could cause EMI, and the user is protected from exposure to electromagnetic radiation generated by the LCD device 1. However, the metal frame 17 makes the LCD device 1 rather heavy and thick.

What is needed, therefore, is a backlight module that can overcome the above-described deficiencies. What is also needed is an LCD device employing such a backlight module.

### SUMMARY

An aspect of the invention relates to a backlight module. The backlight module includes: a light guide plate having a bottom surface and a light incident surface adjacent to the bottom surface; a light source disposed adjacent to the light incident surface of the light guide plate; and a reflective film disposed adjacent to the light guide plate. The reflective film faces the light source and abuts the bottom surface of the light guide plate. The reflective film includes a reflective layer and a metal shielding layer.

A further aspect relates to a liquid crystal display device. The liquid crystal display device includes a liquid crystal panel, and a backlight module opposite to the liquid crystal panel. The backlight module includes a light guide plate having a bottom surface and a light incident surface adjacent to the bottom surface, a light source disposed adjacent to the light incident surface of the light guide plate, and a reflective film disposed adjacent to the light guide plate. The reflective film faces the light source and abuts the bottom surface of the light guide plate. The reflective film includes a reflective layer and a metal shielding layer.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, isometric view of an LCD device according to a preferred embodiment of the present invention.

FIG. 2 is an assembled view of the LCD device of FIG. 1.

FIG. 3 is an enlarged, cross-sectional view taken along line III-III of FIG. 2.

FIG. 4 is an enlarged view of a circled portion IV of FIG. 3.

FIG. 5 is an exploded, isometric view of a conventional LCD device.

### DETAILED DESCRIPTION OF PREFERRED EMBODIMENTS

Reference will now be made to the drawings to describe preferred and exemplary embodiments of the present invention in detail.

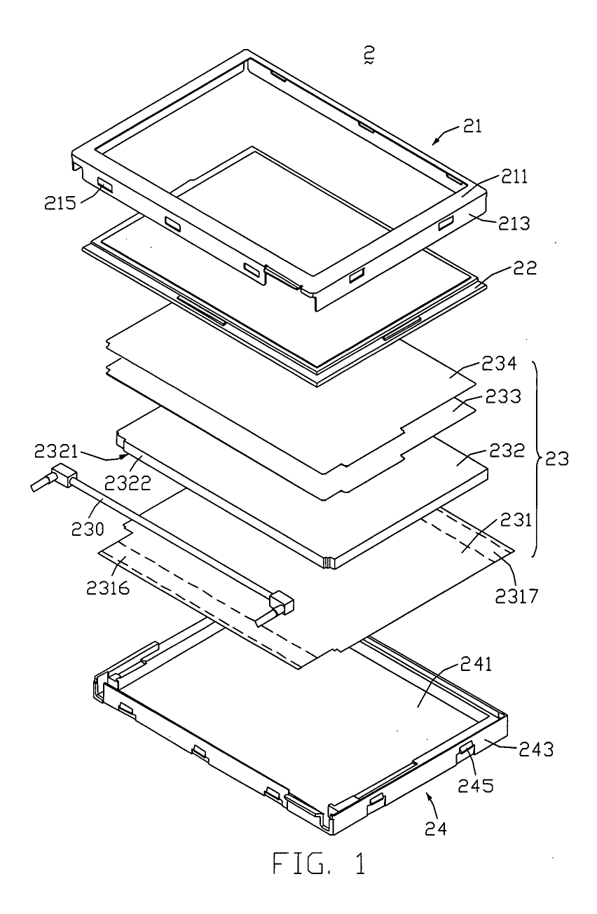

Referring to FIG. 1, an LCD device according to a preferred embodiment of the present invention is shown. The LCD device 2 includes an upper holding frame 21, a liquid crystal panel 22, a backlight module 23, and a lower holding frame 24.

The upper holding frame 21 is a hollow plastic frame, and includes a top wall 211 and four side plates 213 extending downward from four sides (not labeled) of the top wall 211. A plurality of grooves 215 is defined in each side plate 213. The lower holding frame 24 may be made of plastic or the like, and includes a bottom plate 241 and four side plates 243 vertically extending upward from four sides (not labeled) of the bottom plate 241. A plurality of catches 245 is formed at an outer face of each side plate 243. In the illustrated embodiment, the catches 245 are in the form of protrusions. The catches 245 correspond to the grooves 215, respectively.

The liquid crystal panel 22 includes various kinds of high frequency circuits, digital circuits, analog circuits and so on. The liquid crystal panel 22 receives and processes various driving and control signals, and processes these signals for displaying of images. A system ground terminal (not shown) is disposed in the liquid crystal panel 22.

The backlight module 23 is used for providing light beams to illuminate the liquid crystal panel 22. The backlight module 23 includes a light source 230, a reflective film 231, an LGP 232, a diffuser 233, and a BEF 234. The reflective film 231, the LGP 232, the diffuser 233, and the BEF 234 are arranged in that order from bottom to top. The LGP 232 includes a bottom surface 2321 adjacent to the reflective film 231, and a light incident surface 2322 adjoining the bottom surface 2321. The light source 230 is disposed adjacent to the light incident surface 2322. The light source 230 may be a cold cathode fluorescent lamp (CCFL) or the like. The reflective film 231 includes a main portion (not labeled), a first bent portion 2316, and a second bent portion 2317. The first and second bent portions 2316, 2317 respectively extend outward from two opposite lateral sides (not labeled) of the main portion. The main portion corresponds to the bottom surface 2321 of the LGP 232. The first bent portion 2316 corresponds to the light source 230, and has three parts. Preferably, two folding lines are preformed in the first bent portion 2316, the folding lines being between the three parts respectively. Thus, in assembly, the three parts can be bent to form a step-shaped configuration, with two of the parts facing two sides of the light source 230 respectively. The second bent portion 2317 has two parts. Preferably, a folding line is preformed in the second bent portion 2317, the folding line being between the two parts respectively. Another folding line is preformed where the second bent portion 2317 extends from the main portion. Thus, in assembly, the two parts can be bent to form an L-shaped configuration, with one of the parts abutting a side of the light guide plate 232 that is farthest from the incident surface 2321.

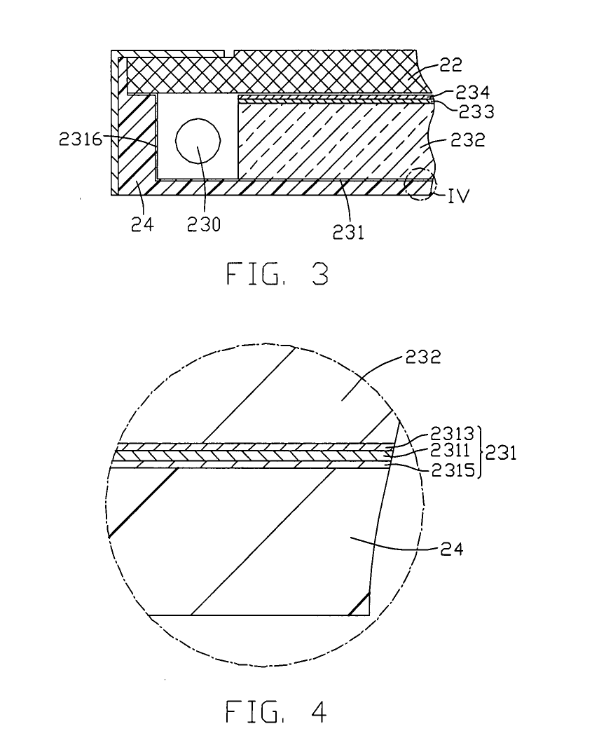

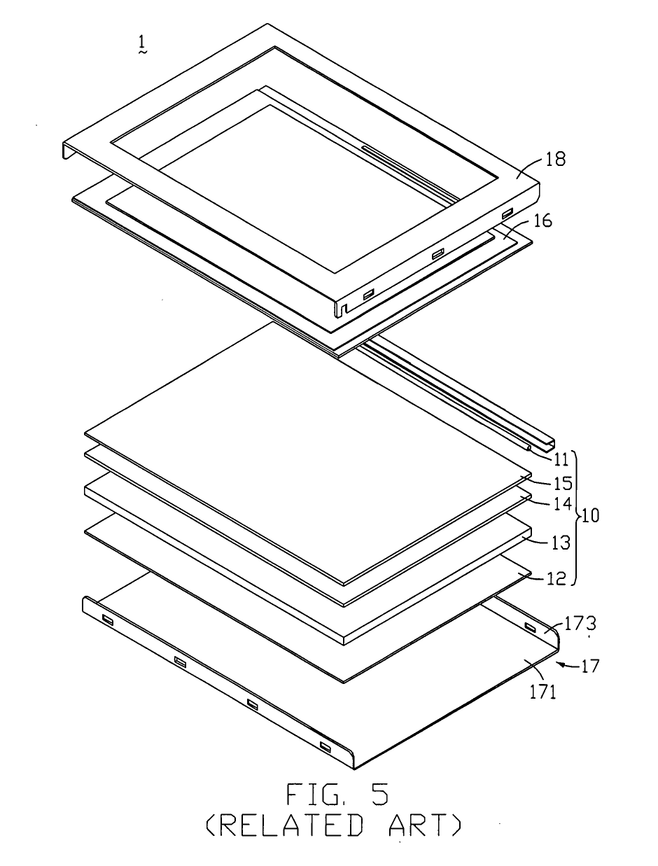

Referring to FIG. 4, this is an enlarged view of a circled portion IV of FIG. 3. The reflective film 231 includes a reflective layer 2313, a base 2311, and a metal shielding layer 2315 arranged in that order from top to bottom. The base 2311 may be made of transparent material, such as polyethylene terephthalate (PET) or polycarbonate (PC). The reflective layer 2313 is made of reflective material having a high reflection ratio, and can be printed on the upper surface of the base 2311. The metal shielding layer 2315 can be formed on the lower surface of the base 2311 by spray coating a conductive paint, attaching a metal foil, metallizing, vapor deposition, sputtering, or electroplating. The metal shielding layer 2315 may be made of indium tin oxide (ITO), nickel, copper, iron, or any suitable alloy containing any of these materials.

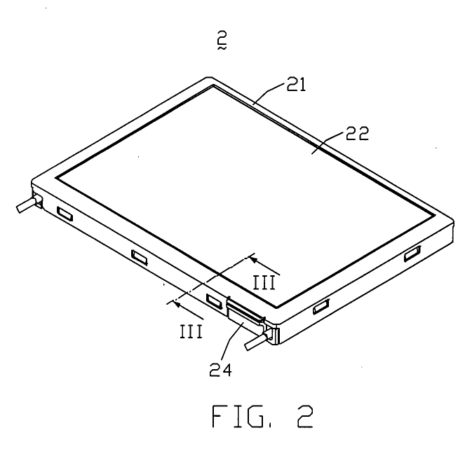

Referring to FIG. 2 and FIG. 3, in assembly, firstly, the backlight module 23 and the liquid crystal panel 22 are accommodated in an accommodating space defined between the bottom plate 241 and the side plates 243 of the lower holding frame 24. The main portion of the reflective film 231 of the backlight module 23 is disposed on the bottom plate 241 of the lower holding frame 24. The first bent portion 2316 of the reflective film 231 is bent to form the step-shaped configuration, which conforms to a configuration of the corresponding side plate 243 of the lower holding frame 24. One part of the first bent portion 2316 is opposite to the light incident surface 2322. The second bent portion 2317 is bent to form the L-shaped configuration. One part of the second bent portion 2317 abuts the side of the light guide plate 232 that is farthest from the incident surface 2321. Secondly, the light source 230 is disposed in a receiving space between the bent portion 2311 and the light incident surface 2322. Finally, the upper holding frame 21 is attached onto the lower holding frame 24, with the grooves 215 of the upper holding frame 21 engagingly receiving the catches 245 of the lower holding frame 24.

Referring also to FIG. 4, the metal shielding layer 2315 is adjacent to the lower holding frame 24. The reflective layer 2313 at two of the parts of the bent portion 2311 of the reflective film 231 is opposite to the light source 230. Thus some of light beams emitted from the light source 230 are reflected back toward the light incident surface 2322 of the LGP 232 by the reflective layer 2313. The reflective layer 2313 at the main portion of the reflective film 231 is opposite to the LGP 232. Some of light beams in the LGP 232 escape out through a bottom surface of the LGP 232. These light beams are reflected back into the LGP 232 by the reflective layer 2313.

In summary, the liquid crystal display 2 utilizes the reflective film 231 having the metal shielding layer 2315 to shield the liquid crystal panel 22 and the backlight module 23 from external electromagnetic radiation, and protect a user from being exposed to electromagnetic radiation generated by the LCD device 2. In addition, the bent portion 2311 of the reflective film 231 is disposed adjacent to two sides of the light source 230. The bent portion 2311 can achieve substantially the same effect as a reflective cover used in a conventional LCD device. Thereby, the LCD device 2 need not be fitted with a reflective cover. This can save costs and simplify the process of assembly of the LCD device 2. Moreover, the lower holding frame 24 made of plastic or the like is typically much lighter and thinner than a metal frame of a conventional LCD device. This makes the LCD device 2 lighter, thinner and more compact than the conventional LCD device.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light guide plate having a bottom surface and a light incident surface adjacent to the bottom surface;
a light source disposed adjacent to the light incident surface of the light guide plate; and
a reflective film disposed adjacent to the light guide plate, the reflective film facing the light source and abutting the bottom surface of the light guide plate;
wherein the reflective film comprises a reflective layer and a metal shielding layer.

2. The backlight module as claimed in claim 1, wherein the reflective film comprises a main portion corresponding to the light guide plate, and a bent portion extending from the main portion and corresponding to the light source.

3. The backlight module as claimed in claim 2, wherein the light source is disposed between the bent portion of the reflective film and the light incident surface of the light guide plate, and the bent portion reflects light beams emitted from the light source generally toward the light incident surface of the light guide plate.

4. The backlight module as claimed in claim 1, wherein the metal shielding layer is made of indium tin oxide.

5. The backlight module as claimed in claim 1, wherein the metal shielding layer is made of metallic material.

6. The backlight module as claimed in claim 1, wherein the reflective film further comprises a base between the metal shielding layer and the reflective layer.

7. The backlight module as claimed in claim 6, wherein the base is made of transparent material.

8. The backlight module as claimed in claim 6, wherein the metal shielding layer is a spray coated conductive paint formed on the base.

9. The backlight module as claimed in claim 6, wherein the metal shielding layer is a metal foil attached on the base.

10. The backlight module as claimed in claim 6, wherein the reflective layer is a reflective material printed on a surface of the base, and the reflective material has a high reflection ratio.

11. A liquid crystal display device, comprising:
a liquid crystal panel; and
a backlight module opposite to the liquid crystal panel, the backlight module comprising:
a light guide plate having a bottom surface and a light incident surface adjacent to the bottom surface;
a light source disposed adjacent to the light incident surface of the light guide plate; and
a reflective film disposed adjacent to the light guide plate, the reflective film facing the light source and abutting the bottom surface of the light guide plate;
wherein the reflective film comprises a reflective layer and a metal shielding layer.

12. The liquid crystal display device as claimed in claim 11, wherein the reflective layer faces the light source and abuts the bottom surface of the light guide plate.

13. The liquid crystal display device as claimed in claim 11, wherein the reflective film comprises a main portion corresponding to the light guide plate, and a bent portion extending from the main portion and corresponding to the light source.

14. The liquid crystal display device as claimed in claim 13, wherein the light source is disposed between the bent portion of the reflective film and the light incident surface of the light guide plate, and the bent portion reflects light beams emitted from the light source generally toward the light incident surface of the light guide plate.

15. The liquid crystal display device as claimed in claim 11, wherein the reflective film further comprises a base between the reflective layer and the metal shielding layer.

16. The liquid crystal display device as claimed in claim 15, wherein the reflective layer is a reflective material printed on a surface of the base, and the reflective material has a high reflection ratio.

17. The liquid crystal display device as claimed in claim 15, wherein the metal shielding layer is a spray coated conductive paint formed on the base.

18. The liquid crystal display device as claimed in claim 15, wherein the metal shielding layer is a metal foil attached on the base.

19. The liquid crystal display device as claimed in claim 11, wherein the metal shielding layer is made of indium tin oxide.

20. The liquid crystal display device as claimed in claim 11, further comprising an upper holding frame and a lower holding frame both made of plastic, wherein the upper holding frame and the lower holding frame are engaged with each other and cooperatively accommodate the liquid crystal panel and the backlight module.
